(19) United States
(12) Patent Application Publication
(10) Pub. No.: US 2023/0314328 A1
(43) Pub. Date: Oct. 5, 2023

(54) BRANCHED FLOW LIGHT FOR SINGLE MOLECULE MICROSCOPY

(71) Applicant: 10x Genomics, Inc., Pleasanton, CA (US)

(72) Inventor: Justin COSTA, Union City, CA (US)

(21) Appl. No.: 18/122,093

(22) Filed: Mar. 15, 2023

Related U.S. Application Data
(60) Provisional application No. 63/321,025, filed on Mar. 17, 2022.

(51) Int. Cl. G01N 21/64

(52) U.S. Cl. CPC G01N 21/6458; G01N 2021/6471

(57) ABSTRACT

A branched flow imaging system capable of fluorescence microscopy is disclosed, the system including a light source configured to emit excitation light, a sample slide configured to hold a sample to be imaged, a medium providing a potential with a correlation length greater than the excitation light wavelength, and a sensor configured to capture fluorescence emission light emitted by the plurality of fluorophores of the sample. The medium may be positioned such that the excitation light branches into a plurality of light channels that are incident upon the sample slide so that each of the light channels randomly excites an individual fluorophore molecule of the sample. The degree of randomness of the distribution of the light channels on the sample may be determined by a difference between the correlation length of the potential and the wavelength of the excitation light.

### CROSS-REFERENCE TO RELATED APPLICATION

This application claims priority to U.S. Provisional Patent Application No. 63/321,025, filed on Mar. 17, 2022, entitled “BRANCHED FLOW LIGHT FOR SINGLE MOLECULE MICROSCOPY,” which is herein incorporated by reference in its entirety for all purposes.

### FIELD

The present disclosure relates generally to fluorescence microscopy, and more specifically to fluorescence microscopy using branched flow light to illuminate a sample.

### BACKGROUND

Fluorescence microscopes are widely used tools that use fluorescence to image a sample. In fluorescence microscopy, fluorophores are excited by excitation light of a fluorophore-dependent wavelength and then emit fluorescence emission light of a fluorophore-dependent wavelength. Images of the fluorescence can be detected by a camera. Fluorescence microscopes are particularly useful in the biological fields because they allow researchers to collect high resolution images without damaging sensitive samples.

### SUMMARY OF THE INVENTION

Despite its popularity and advantages, fluorescence microscopy can have issues with molecular and optical crowding. Conventional fluorescence microscopes illuminate samples using beams of excitation light with large cross-sectional areas which have a high probability of exciting multiple fluorophores at the same time. Thus, when a sample—such as a sample being imaged as part of an in situ application—is illuminated, it may be difficult or impossible to control which fluorophores will fluoresce. Often, a large number of fluorophores in a sample, even a majority of fluorophores in a sample, will fluoresce simultaneously. If these fluorophores are too close to one another, resolving individual fluorophores or otherwise resolving useful information from the collected image data may be difficult or impossible as a result of optical crowding. While some microscopy approaches have been developed to reduce molecular or optical crowding, existing techniques do not address both issues. Furthermore, existing approaches generally require treating the sample with additional chemicals (e.g., REDOX buffers) which make experimental realization challenging.

As such, there is need for fluorescence microscopy techniques that address molecular and optical crowding and are easily implemented by researchers. Recently, it has been demonstrated that visible light can, under appropriate conditions, undergo branched flow. Branched flow is a wave-dynamics phenomenon in which rays or waves are scattered by a medium in such a way so as to form a tree-like pattern of light channels. While branched flow has historically been observed in two-dimensional electron gases and in ocean dynamics, branched flow of visible light propagating through soap bubbles has also recently been demonstrated.

Disclosed herein are systems and methods that leverage branched flow of light (including visible light) to generate spatial patterns of branched excitation light that may be used as a sparse excitation pattern in fluorescence microscopy. Using branched-flow light for illumination/excitation, cross-sectional area of each of the light channels may be significantly smaller than the cross-sectional area of a light beam that has not undergone branched flow, allowing for a light channel to excite a smaller number of target molecules, including a single target molecule. The pattern of channels may also be sparsely dispersed over an area that is significantly larger than the cross-sectional area of each channel, allowing for molecules in a sample to be sparsely illuminated/excited. Additionally, the spatial distribution of light channels generated from branched flow can be highly random, allowing for illumination/excitation of randomly-spatially-distributed molecules in a sample. The thinly dispersed pattern of light channels combined with the small cross-sectional area of each individual channel significantly reduces the probability of multiple fluorophores being simultaneously excited by any given channel. Therefore, by applying this sparse excitation pattern to a fluorescence sample, the above-described issues of molecular and optical crowding in fluorescence microscopy may be mitigated. That is, using branched flow light, rather than a single beam of light, to illuminate a fluorescence sample may cause a small, spatially-randomly-distributed subset of the individual fluorophores in the sample to be excited at once, thereby avoiding situations in which a large portion or a majority of spatially-proximate fluorophores simultaneously fluoresce. The systems and methods of the present disclosure avoid optical and molecular crowding by harnessing branched flow light to stochastically excite individual fluorophores in a manner hereto unachieved by conventional means.

Light undergoes branched flow when it travels through a medium having a physical property that varies in a specific manner. Specifically, the variation must occur along the optical path of the light and a scale of the variation must be greater than a wavelength of the light. A film of soap is an example of such a medium. A soap film may vary in thicknesses due to the formation of bubbles; the variation in thickness of the soap film may cause the medium to have a varying correlation length which causes light that is directed through the film to undergo branched flow.

In an exemplary embodiment of the present disclosure, a fluorescence microscope is formed by directing a beam of light through a soap film that is floating atop a reservoir of fluid. The beam is directed toward a sample that is disposed on a slide which forms one wall of the reservoir. As the light beam travels through the film, it branches into a plurality of light channels in a plane within the soap film at the surface of the fluid; when the light channels hit the sample, they are absorbed by a subset of fluorophores in the sample that fall in an optical path of one of the light channels in the branched flow plane. The fluorescence emitted by these fluorophores is captured by a camera on the opposite side of the slide. In order to capture a complete image of the sample, fluid can be pumped in and out of the reservoir. This allows the sample to be scanned by the branched flow illumination pattern in a direction perpendicular to the direction of light branching in the soap film. As a result, fluorophores in different areas of the sample are caused to fluoresce at different times, reducing molecular crowding and allowing the camera to capture a complete, high resolution image of the sample.

In some embodiments, a method of imaging a sample using branched flow light comprises directing excitation light from a light source through a potential toward a sample comprising a plurality of fluorophores, wherein a correlation length of the potential is greater than or equal to 350 nm and less than or equal to 800 nm, and wherein the correlation length of the potential is greater than a wavelength of the excitation light, such that the excitation light branches into a plurality of light channels that are incident upon and excite the plurality of fluorophores, and capturing an image of fluorescence emission emitted by the fluorophores.

In some embodiments, the light from the light source has a wavelength of greater than or equal to 330 nanometers and less than or equal to 780 nanometers.

In some embodiments, the light from the light source is coherent.

In some embodiments, the potential comprises a soap membrane.

In some embodiments, the correlation length of the potential characterizes variation of at least one dimension of the medium in at least one spatial direction.

In some embodiments, the variation of at least one dimension of the medium in at least one spatial direction is in the spatial direction of the propagation of the excitation light.

In some embodiments, the excitation light from the light source is pulsed.

In some embodiments, the plurality of light channels are capable of random optical address of individual molecules.

In some embodiments, a degree of randomness of the distribution of the light channels is determined by a difference between the correlation length of the potential and the wavelength of the excitation light.

In some embodiments, a fluorescence imaging system comprises a light source configured to emit excitation light, a sample slide configured to hold a sample to be imaged, a medium providing a potential, wherein the medium is disposed in an optical path between the light source and the sample slide, wherein a correlation length of the potential is greater than or equal to 350 nm and less than or equal to 800 nm, wherein the correlation length of the potential is greater than a wavelength of the excitation light, and wherein the medium is positioned such that the excitation light branches into a plurality of light channels that are incident upon the sample slide, such that the light channels excite a plurality of fluorophores of the sample, and a sensor configured to capture fluorescence emission light emitted by the plurality of fluorophores of the sample.

In some embodiments, the excitation light from the light source has a wavelength of greater than or equal to 330 nanometers and less than or equal to 780 nanometers.

In some embodiments, the light from the light source is coherent.

In some embodiments, the correlation length of the potential characterizes variation of at least one dimension of the medium in at least one spatial direction.

In some embodiments, the at least one spatial direction is the spatial direction of the propagation of the excitation light.

In some embodiments, the excitation light from the light source is pulsed.

In some embodiments, the medium comprises a soap membrane.

In some embodiments, the imaging system further comprises a reservoir containing a liquid, wherein the soap membrane floats on the liquid.

In some embodiments, the imaging system further comprises a pump configured to adjust a volume of the liquid in the reservoir.

In some embodiments, a position of the light source is adjustable such that the excitation light is directed into the medium as the volume of the liquid in the reservoir is adjusted.

In some embodiments, one or more optical components in the optical path between the light source and the sample slide are adjustable such that the excitation light is directed into the medium as the volume of the liquid in the reservoir is adjusted.

In some embodiments, the imaging system comprises an agitation device configured to agitate the liquid in the reservoir.

In some embodiments, the sample slide forms a portion of a wall of the reservoir.

In some embodiments, a length of the reservoir is adjustable.

In some embodiments, the imaging system further comprises an optical filter wheel disposed in a fluorescence emission optical path between the sample slide and the sensor.

In some embodiments, the plurality of light channels are capable of random optical address of individual molecules.

In some embodiments, a degree of randomness of the distribution of the light channels is determined by a difference between the correlation length of the potential and the wavelength of the excitation light.

In some embodiments, any one or more features of any of the above embodiments may be combined, in whole or in part, with one another and/or with any other features disclosed herein.

### BRIEF DESCRIPTION OF THE FIGURES

The invention will now be described, by way of example only, with reference to the accompanying drawings.

FIG. 1 shows a diagram of an imaging system using branched flow light, according to some embodiments.

FIGS. 2A-2B show systems for exciting fluorophores using unbranched (FIG. 2A) and branched (FIG. 2B) light, according to some embodiments.

FIG. 3 shows a method of imaging a sample using branched flow light, according to some embodiments.

FIG. 4 shows a branched flow imaging system, according to some embodiments.

### DETAILED DESCRIPTION

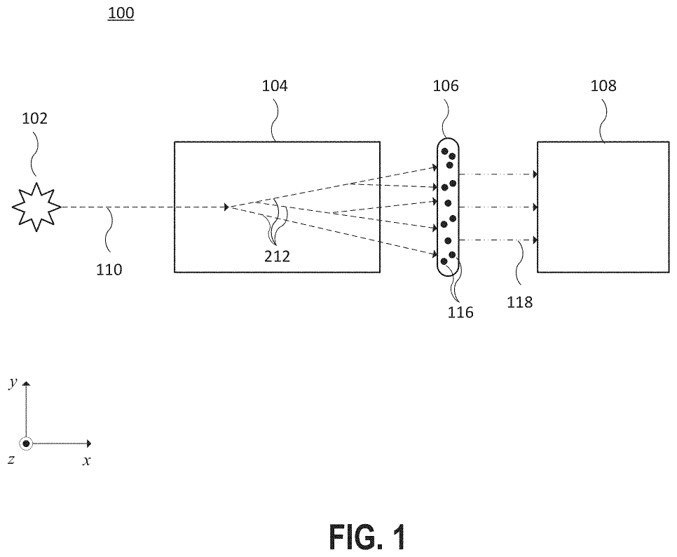

Reference will now be made in detail to various embodiments, examples of which are illustrated in the accompanying drawings. Wherever possible, the same reference numbers will be used throughout the drawings to refer to the same or like parts. Moreover, use of the indefinite article “a” or “an” in the specification and the claims is meant to include one or more of the feature that it introduces, unless otherwise indicated. FIG. 1 shows a diagram of an imaging system 100 using branched flow light according to some embodiments. In some embodiments, imaging system may include or may be provided as a fluorescence microscope. As shown, system 100 comprises a light source 102, a potential 104, a sample 106, and an image sensor 108. Sample 106 may comprise a plurality of fluorophores 116 which fluoresce following absorption of excitation light of a suitable (fluorophore-dependent) wavelength. Light source 102 may be configured to emit excitation light 110 of an appropriate wavelength λ such that, when said light is absorbed by the plurality of fluorophores 116, the plurality of fluorophores 116 are caused to fluoresce.

FIG. 1 shows excitation light 110 travelling from light source 102 to (and into) potential 104 along a straight optical path. For clarity, the direction of the initial optical path if excitation light 110 is denoted as the positive x-direction (rightward in FIG. 1). The vertical direction is denoted as the y-direction, with the positive, with the positive y-direction being upward in FIG. 1. Finally, the z-direction points in and out of the page in FIG. 1, with the positive z-direction pointing out of the page.

In some embodiments, light source 102 may include a coherent light source such as a laser. In some embodiments, light source 102 may be configured to emit pulses of excitation light 110. In some embodiments, excitation light 110 may include light in the infrared range, the visible range, and/or the ultraviolet range. In some embodiments, a wavelength λ of excitation light 110 may be less than or equal to 380, 450, 480, 500, 560, 590, 620, or 750 nm. In some embodiments, a wavelength λ of excitation light 110 may be greater than or equal to 380, 450, 480, 500, 560, 590, 620, or 750 nm. In some embodiments, a wavelength λ of excitation light 110 may be selected to excite (e.g., to be equal to or about equal to an excitation wavelength for) one or more fluorophores including Quantum Dots, Carbon Dots, Cyanine, Alexa, Atto, and/or fluorescent proteins. In some embodiments, a wavelength λ of excitation light 110 may be equal to exactly or about 488, 532, 590, or 647 nm.

In some embodiments, light source 202 may be configured to transmit excitation light 210 to potential 204 as a plane wave. In some embodiments, light source 202 may be configured to transmit excitation light 210 to potential 204 using a single mode fiber. In some embodiments, light source 202 may be configured to transmit excitation light 210 to potential 204 as a beam of any suitable shape and/or any suitable beam profile (e.g., Gaussian, flat top, elliptical, etc.). In some embodiments, any suitable spot-size may be used for excitation light 210. In some embodiments, any suitable pulsing scheme or other timing scheme may be used for excitation light 210. In some embodiments, light source 202 may have a power of about 1-10 mW or less, between about 10-25, 25-50, 50-75, 75-100, 100-150, 150-200, 200-500, 500-750, 750-100-, 1000-5000, 5000-10,000, 10,000-20,000, 20-30,000, 30-50,000, 50,000-75,000, or 75,000-100,000 mW, or greater than about 100,000 mW. In some embodiments, light source 202 may have a power greater than or equal to 1, 10, 25, 50, 75, 100, 150, 200, 500, 750, 1000, 5000, 10,000, or 20,000 mW. In some embodiments, light source 202 may have a power less than or equal to 1, 10, 25, 50, 75, 100, 150, 200, 500, 750, 1000, 5000, 10,000, or 20,000 mW.

In some embodiments, potential 104 may be weakly disordered. A correlation length of potential 104 may be greater than a wavelength of excitation light 110. As a result of the correlation length being greater than a wavelength of excitation light 110, as excitation light 110 travels through potential 104, excitation light 110 may be caused to undergo branched flow. As shown in FIG. 1, excitation light 110 may branch into a plurality of separate light channels 112.

In some embodiments, the correlation length of potential 104 may be greater than or equal to 300 nm, 350 nm, 400 nm, 450 nm, 500 nm, 550 nm, 600 nm, 650 nm, 700 nm, 750 nm, 800 nm, or 850 nm. In some embodiments, the correlation length of potential 104 may be less than or equal to 300 nm, 350 nm, 400 nm, 450 nm, 500 nm, 550 nm, 600 nm, 650 nm, 700 nm, 750 nm, 800 nm, or 850 nm. In some embodiments, the correlation length of potential 104 may be greater than or equal to 350 nm and less than or equal to 800 nm.

In some embodiments, potential 104 may be provided by a medium. The medium may be disposed in an optical path between light source 102 and sample 106. In some embodiments, the correlation length of potential 104 may characterize a variation of at least one dimension of the medium (e.g., at least one of the x-dimension, the y-dimension, or the z-dimension) along at least one spatial direction (e.g., at least one of the x-direction, the y-direction, or the z-direction). In some embodiments, this variation of at least one dimension of the medium in at least one spatial direction may be in the direction of propagation of excitation light 110, in that the z-directional dimension of the medium and/or the y-directional dimension of the medium may vary in thickness along the x-direction. In some embodiments, a thickness of the z-directional or y-directional dimension of the medium along the x-direction may vary by greater than or equal to 0.5, 1, 2, 5, 10, 15, 20, 25, 50, 100, 200, 300, 400, 500, 750, 1000, 1250, or 1500 nm. In some embodiments, a thickness of the z-directional or y-directional dimension of the medium along the x-direction may vary by less than or equal to 0.5, 1, 2, 5, 10, 15, 20, 25, 50, 100, 200, 300, 400, 500, 750, 1000, 1250, or 1500 nm. In some embodiments, a thickness of the z-directional or y-directional dimension of the medium along the x-direction may vary by greater than or equal to 0.01%, 0.05%, 0.1%, 0.5%, 1%, 5%, 10%, 50%, 90%, 95%, 99%, 99.5%, 99.9%, 99.95%, or 99.99% of a thickness of the medium. In some embodiments, a thickness of the z-directional or y-directional dimension of the medium along the x-direction may vary by less than or equal to 0.01%, 0.05%, 0.1%, 0.5%, 1%, 5%, 10%, 50%, 90%, 95%, 99%, 99.5%, 99.9%, 99.95%, or 99.99% of a thickness of the medium.

In some embodiments, potential 104 may be provided by a liquid comprising a soap membrane. In some embodiments, the soap membrane may comprise a sodium salt of a fatty acid or a potassium salt of a fatty acid. In some embodiments, the liquid may comprise water. The liquid may be contained in a reservoir and the soap membrane may float on the surface of the liquid. The thickness of the soap membrane may vary in thickness in the direction of propagation of excitation light 110 (e.g., the soap membrane thickness may vary in the x-direction). In some embodiments, light source 102 may be configured to direct excitation light 110 through the soap membrane floating on the surface of the liquid, thereby causing excitation light 110 to undergo branched flow and split into the plurality of light channels 112.

In some embodiments, alterations to the composition of the soap membrane may be implemented in order to control the correlation length of potential 104. In some embodiments, alterations to the composition of the soap membrane may comprise adding or removing types of soaps, altering the concentration of a soap in the liquid, adjusting the temperature of the liquid and/or the ambient environment, and/or changing the amount of turbulence in the liquid.

In some embodiments, one or more soaps may be selected for the soap membrane based on the different lengths and saturations of fatty acid tails of different soap types. In some embodiments, hydrophobic and/or amphiphilic additives may be used to controllably adjust contour lengths of the soap film.

In some embodiments, the soap membrane may include different types of soaps. For example, in some embodiments, the soap membrane may comprise greater than or equal to two, three, four, five, ten, twenty, or fifty types of soaps. In some embodiments, the soap membrane may comprise less than or equal to two, three, four, five, ten, twenty, or fifty types of soaps. In some embodiments, the soap membrane may comprise at least two different types of soap, wherein the ratio of a first type of the at least two types of soap to a second type of the at least two types of soap may be less than or equal to 1, 2, 3, 4, 5, 10, or 100. In some embodiments, the ratio of a first type of the at least two types of soap to a second type of the at least two types of soap may be greater than or equal to 1, 2, 3, 4, 5, 10, or 100.

In some embodiments, the volume percent of a type of soap in the liquid may be less than or equal to 1%, 5%, 10%, 25%, or 50%. In some embodiments, the volume percent of a type of soap in the liquid may be greater than or equal to 1%, 5%, 10%, 25%, or 50%. In some embodiments, the volume percent of a type of soap in the liquid may be 1-5%, 5-10%, 10-20%, 20-30%, 30-40%, 40-50%, or 50-100%.

In some embodiments, the temperature of the liquid may be greater than or equal to 0, 10, 25, 50, 75, or 100° C. In some embodiments, the temperature of the liquid may be less than or equal to 0, 10, 25, 50, 75, or 100° C. In some embodiments, the temperature of the liquid may be 10-20° C., 20-30° C., 30-40° C., 40-50° C., 50-60° C., 60-70° C., or 70-100° C.

In some embodiments, one or more compounds that are miscible in the liquid may be added in order to alter the surface and/or interfacial chemistry. Specifically, one or more compounds may be added to the liquid in order to control or change the surface tension of the liquid, a viscosity of the liquid, a refractive index of the liquid, or a contour length along the soap membrane axis. For example, if the liquid primarily comprises water, a small volume of ethanol may be added in order to reduce the surface tension of the soap film. This, in turn, may alter the correlation length of potential 104.

One advantage of using soap films or other mediums in the manner disclosed herein is that the soap film (or other medium is being used to induce branched flow) may be tuned around a very wide spectrum of wavelengths.

In some embodiments, system 100 may be housed in an environment with an ambient temperature less than or equal to 0, 10, 25, 50, 75, or 100° C. In some embodiments, system 100 may be housed in an environment with an ambient temperature greater than or equal to 0, 10, 25, 50, 75, or 100° C. In some embodiments, system 100 may be housed in an environment with an ambient temperature of 10-20° C., 20-30° C., 30-40° C., 40-50° C., 50-60° C., 60-70° C., or 70-100° C. In some embodiments, a temperature of potential 104 (e.g., as provided by a soap film floating on top of a reservoir of water) may be the same as an ambient temperature, warmer than an ambient temperature, or cooler than an ambient temperature. In some embodiments, one or more temperature control devices may be provided to control an ambient temperature around system 100 and/or to control a temperature of potential 104 (e.g., by heating a reservoir of water).

In some embodiments, light channels 112 may be directed to be incident upon sample 106. One or more of light channels 112 may be absorbed by one or more of the plurality of fluorophores 116 in sample 106. The plurality of fluorophores 116 that absorb light channels 112 may then emit fluorescence emission 118, which may be detected by image sensor 108. Since each of the light channels 112 may have a smaller area of incidence than the unbranched excitation light 110, the plurality of fluorophores 116 that absorb light may be less than the total number of fluorophores in sample 106. Thus, the branched light may provide sparse excitation. As a result, only a subset of the total number of fluorophores in sample 106 may emit fluorescence emission 118. In some embodiments, the subset of fluorophores in sample 106 that are caused to fluoresce may be spatially distributed from one another in a random manner. In some embodiments, a fluorophore molecule that is able to be excited by a light channel may be referred to as an “optical address,” in that that fluorophore molecule is capable of being “optically addressed” by a branched flow light channel. Thus, it may be said that the systems disclosed herein are capable of randomly optically addressing fluorophores, or that they are capable of random optical address. The degree of randomness of the sparse excitation pattern may depend on the magnitude of the difference between the correlation length of potential 104 and the wavelength of excitation light 110. The resulting disordered spatial point excitation of individual molecules allows for optically addressing in a manner distinctly different from conventional excitation such as beam light resulting in all, or a majority of fluorophores being excited at once, which directly leads to optical crowding. As such, harnessing branched flow light for fluorescence microscopy may mitigate optical crowing by exciting a randomly-spatially-distributed subset of fluorophores that are sparsely distributed in sample 106. In some embodiments, all of the fluorophores in sample 106 may be excited, but the sparse excitation provided by the branched light may mean that the illumination time required to excite all of the fluorophores is longer than if unbranched excitation light were used.

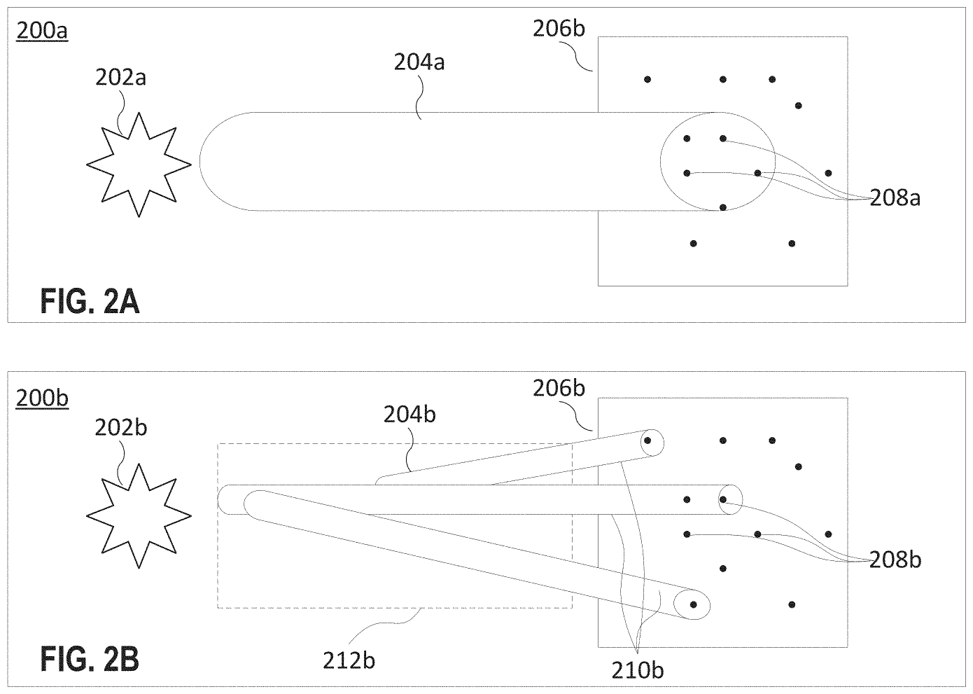

FIGS. 2A-2B show a comparison of excitation using conventional fluorescence microscopy techniques (FIG. 2A) versus branched flow light (FIG. 2B) according to some embodiments. Specifically, FIGS. 2A-2B illustrate system 200a and 200b, respectively for exciting a plurality of fluorophores (208a and 208b, respectively) in a sample (206a and 206b, respectively) using excitation light (204a and 204b, respectively) generated by a light source (202a and 202b, respectively). As shown, system 200a illuminates/excites a densely-packed set of fluorophores 208a using a light beam, while system 200b generates light channels 210b using medium 212b, such that randomly-spatially-distributed fluorophores 208b are optically addressed. In some embodiments, systems 200a and 200b (and their subcomponents) may share any one or more characteristics in common with system 100 (and its corresponding subcomponents) described above.

As shown in FIG. 2A, conventional fluorescence microscopy techniques may use a single beam of excitation light 204a. This single beam of excitation light 204a may have a relatively wide cross-section capable of simultaneously optically addressing a large number of molecules that are located close by one another. As a result, a large number of the plurality of fluorophores 208a may simultaneously fluoresce, potentially causing important information about the sample to be lost. This problem may be further exacerbated if excitation light 204a excites areas of sample 206a having a particularly high density of fluorescent molecules (e.g., having high molecular crowding).

In FIG. 2B, on the other hand, excitation light 204b is shown undergoing branched flow. To cause excitation light 204b to undergo branched flow, excitation light 204b may be directed through a potential 212b, which may have a correlation length greater than a wavelength of excitation light 204b. As excitation light 204b travels through medium 212b, it may form a sparse pattern of tree-like channels 210b. The cross-section of each channel 210b may be significantly smaller than the cross section of an excitation light beam used in conventional fluorescence microscopy techniques. As such, each channel may only excite a small number of molecules (e.g., a small number of optical addresses) and thus may thus only cause a small, sparsely distributed number of the plurality of fluorophores 208b to fluoresce at any given time.

The sparse excitation pattern generated by the excitation light channels 210b may be highly stochastic and dependent upon one or more physical properties of potential 212b. In some embodiments, the randomness of the excitation pattern may be depend on the difference between a correlation length of potential 212b and a wavelength of excitation light 204b. In some embodiments, if the difference between a correlation length of potential 212b and a wavelength of excitation light 204b is small, the excitation pattern may be highly random. In some embodiments, this randomness may reduce optical and molecular crowding by causing fluorophores located at sparsely and randomly distributed locations to fluoresce, thus increasing the resolution of images that can be captured of sample 206b.

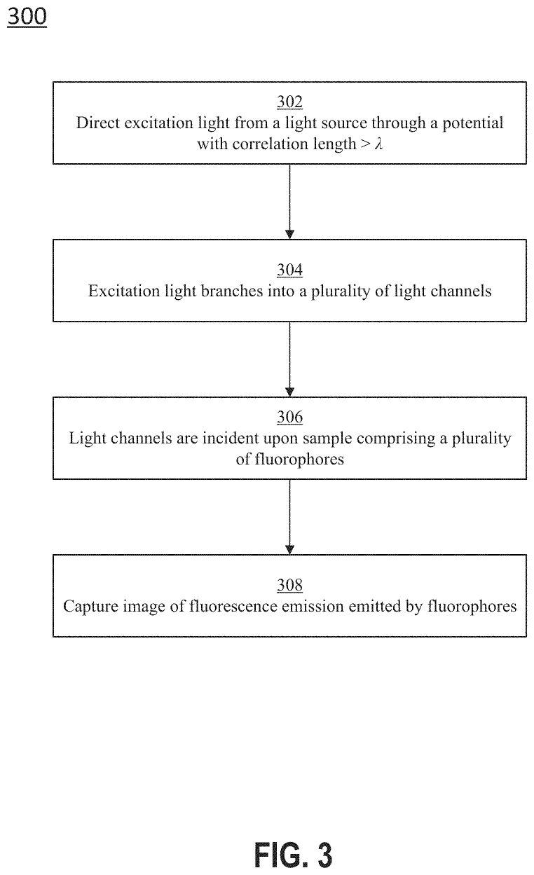

FIG. 3 shows a method 300 of imaging a sample using branched flow light, according to some embodiments. Method 300 may be performed at a fluorescence microscope such as system 100 shown in FIG. 1.

In some embodiments, in a first step 302, excitation light comprising light having a wavelength λ may be directed from a light source through a potential with a correlation length greater than λ. In some embodiments, the light source may include features of light source 102 of system 100 shown in FIG. 1. For example, in some embodiments, the light source may be a laser. In some embodiments, the excitation light may comprise visible light, infrared light, and/or ultraviolet light. In some embodiments, the light source may be continuous or pulsed.

In some embodiments, the potential may include features of potential 104 shown in FIG. 1. Optionally, the potential may be provided by a medium. In some embodiments, a correlation length of the potential may characterize a variation of at least one dimension of the medium in at least one spatial direction. The variation of at least one dimension of the medium in at least one spatial direction may be a variation in a direction of propagation of the excitation light.

In some embodiments, at step 304, the excitation light may undergo branched flow and may be caused to branch into a plurality of light channels. The branching of the excitation light may occur as the excitation light travels through the potential. Optionally, the branching of the excitation light may be controlled by changing a correlation length of the potential. In some embodiments, changing a correlation length may comprise altering one or more characteristics of a medium that provides the potential. For example, in some embodiments, changing a correlation length may comprise changing a volume, a concentration, a temperature, or another physical or chemical feature of a medium providing the potential.

Optionally, method 300 may include one or more operations for configuring potential 104 in order to modify one or more characteristics, including one or more optical properties, of potential 104.

For example, method 300 may include one or more steps for modifying a material composition of potential 104 (e.g., by adding one or more fluids to a solution comprising potential 104).

Method 300 may include one or more steps for modifying spatial dimensions, properties, or arrangement of potential 104, for example by: altering a thickness of potential 104 (e.g., by adding soap to a reservoir to create a thicker soap film), changing the dimensions of a reservoir on which potential 104 is disposed to make the optical path through the potential longer or shorter, and/or moving a position of potential 104 (e.g., by pumping water in to or out of a reservoir on which a soap film is floated in order to cause the soap film to move laterally with respect to the optical path). In some embodiments, moving a position of potential 104 laterally to the optical path may cause sweeping of the light channels such that a one-dimensional line of light-channel illumination spots may be swept over a two-dimensional sample area by moving a position of the potential 104 during illumination.

In some embodiments, method 300 may include one or more steps for modifying a temperature of potential 104, for example by using one or more heating or cooling devices.

In some embodiments, method 300 may include one or more steps for agitating potential 104, for example by introducing vibrations and/or turbulence to potential 104.

In some embodiments, method 300 may include one or more steps for modifying a density (e.g., a packing density) of potential 104, for example by modifying a packing density of a soap film.

Any of the one or more operations for configuring potential 104 may be performed before the excitation light is caused to flow through potential 104 and/or during the time at which the excitation light is flowing through potential 104.

In some embodiments, at step 306, the channels of excitation light may be received at a sample to be imaged, such that the light channels are incident upon one or more fluorophores of the sample. A plurality of the fluorophores may absorb the channels of excitation light and, as a result, may be caused to fluoresce in response to excitation by the excitation light.

At step 308, an image of the fluorescence emission may be captured. In some embodiments, the image of the fluorescence emission may be captured by an image sensor, such as sensor 108 shown in FIG. 1.

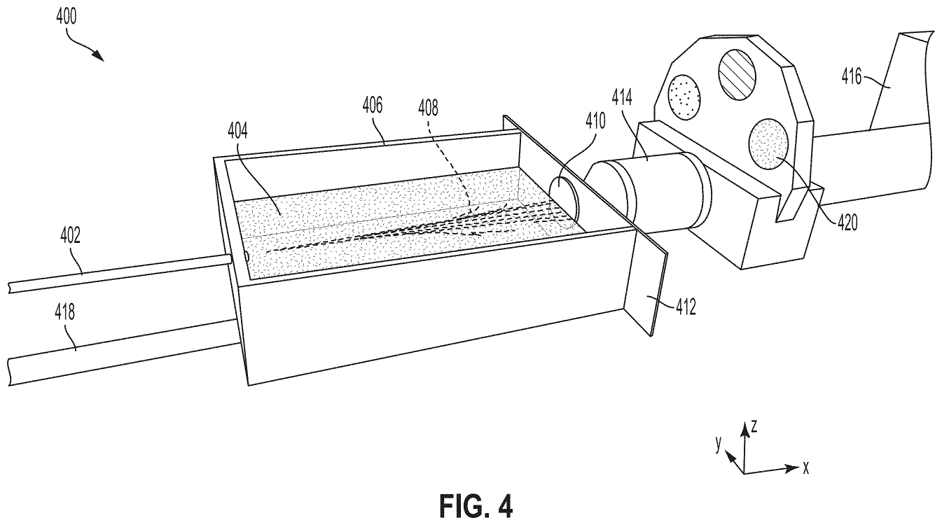

FIG. 4 shows a branched flow imaging system 400, according to some embodiments. In some embodiments, system 400 (and its subcomponents) may share any one or more characteristics in common with system 100 (and its corresponding subcomponents). As shown in FIG. 4, excitation light 402 is directed from a light source (not pictured) through a medium 404 housed in a reservoir 406. As excitation light 402 travels through medium 404, it may be caused to branch into a plurality of light channels 408. The plurality of light channels 408 may be received at a sample 410 held on a sample slide 412. One or more fluorophores in sample 410 may be excited by the light channels, and fluorescence emission emitted by the one or more fluorophores may be captured by camera 416. Spatial directions corresponding to those in FIG. 1 have been indicated. The x-direction is the direction parallel to the optical path of excitation light 402. The y-direction is the direction parallel to sample slide 412. The z-direction is the vertical direction parallel to the walls of reservoir 406.

In some embodiments, excitation light 402 may have properties of excitation light 110 shown in FIG. 1. Optionally, excitation light 402 may be coherent. In some embodiments, a wavelength λ of excitation light 402 may be in the visible range, the infrared range, and/or the ultraviolet range. In some embodiments, a wavelength λ of excitation light 402 may be less than or equal to 380, 450, 480, 500, 560, 590, 620, or 750 nm. In some embodiments, a wavelength λ of excitation light 402 may be greater than or equal to 380, 450, 480, 500, 560, 590, 620, or 750 nm.

Medium 404 may be configured to provide a potential. In some embodiments, a potential provided by medium 404 may be weakly disordered, e.g., the potential may have a correlation length greater than a wavelength λ of excitation light 402. In some embodiments, medium 404 may comprise a liquid and a soap membrane. Optionally, the liquid may comprise water. Altering medium 404 may allow a correlation length of a potential provided by medium 404 to be controlled. In some embodiments, altering medium 404 in order to control a correlation length may comprise one or more of: adding or removing one or components of medium 404, changing the concentration of one or more components of medium 404, changing the temperature of medium 404, or changing the temperature of an environment surrounding system 400. Optionally, system 400 may comprise an agitation device configured to agitate (e.g., add turbulence to) medium 404.

As shown, medium 404 may be contained in reservoir 406. In some embodiments, reservoir 406 may be configured to hold less than or equal to 0.5, 1, 5, 10, or 20 liters of a liquid. In some embodiments, reservoir 406 may be configured to hold greater than or equal to 0.5, 1, 5, 10, or 20 liters of a liquid. In some embodiments, reservoir 406 may be configured to hold 0-1, 1-2, 2-3, 3-4, 4-5, 5-10, or 5-20 liters of a liquid. Optionally, reservoir 406 may be cuboid. In some embodiments, a length of a side of reservoir 406 (e.g., in the x-direction or the y-direction) may be less than or equal to 1, 5, 10, 25, 50, or 100 inches. In some embodiments, a length of a side of reservoir 406 may be greater than or equal to 1, 5, 10, 25, 50, or 100 inches. In some embodiments, a length of a side of reservoir 406 may be 1-5, 5-10, 10-25, 25-50, or 50-100 inches. In some embodiments, a depth of reservoir 406 (e.g., in the z-direction) may be less than or equal to 1, 5, 15, 25, or 50 inches. In some embodiments, a depth of reservoir 406 may be greater than or equal to 1, 5, 15, 25, or 50 inches. In some embodiments, a depth of reservoir 406 may be 1-5, 5-15, 15-25, or 25-50 inches.

Optionally, one or more dimensions of reservoir 406 may be adjustable in order to modify the manner in which light channels 408 are formed and/or to change a position at which light channels 408 are formed. In some embodiments, a length of one or more sides of reservoir 406 may be configured to be adjusted by less than or equal to 0.5, 1, 5, 10, or 20 inches. In some embodiments, a length of one or more sides of reservoir 406 may be configured to be adjusted by greater than or equal to 0.5, 1, 5, 10, or 20 inches. In some embodiments, a length of one or more sides of reservoir 406 may be configured to be adjusted by 0-0.5, 0-1, 0-5, 0-10, or 0-20 inches.

For example, an x-directional length of reservoir 406 may be lengthened to allow the formation of more light channels 408 and to allow for light channels 408 to spread over a wider y-directional distance; conversely, an x-directional length of reservoir 406 may be shortened to allow the formation of fewer light channels 408 and to cause light channels 408 to spread over a shorter y-directional distance.

In some embodiments, reservoir 406 may be configured to hold sample slide 412. Optionally, sample slide 412 may form a side of reservoir 406.

In some embodiments, sample 410 may comprise fluorophores that fluoresce after absorbing excitation light 402. Excitation light channels 312 may be received by some or all of the fluorophores in sample 410. Because light channels 312 may be absorbed by only a subset of the total number of fluorophores in sample 410, only a subset of the total number of fluorophores may be caused to fluoresce, and/or the fluorophores my fluoresce at a slower rate over time than if unbranched excitation light were used. Thus, the techniques described herein may be used to create sparse excitation that may reduce molecular crowding for imaging in in situ applications.

In some embodiments, excitation light 402 may be directed through a surface layer of medium 404. Optionally, system 400 may comprise a pump 418 configured to adjust the volume of medium 404 in reservoir 406. As pump 418 increases or decreases the volume of medium 404 in reservoir 406, the location of the surface layer of medium 320 may change. For example, if pump 418 increases the volume of medium 404 in reservoir, the surface layer may move in the positive z-direction. Similarly, if pump 418 decreases the volume of medium 404 in reservoir 406, the surface layer may move in the negative z-direction. In some embodiments, the horizontal position (in the y-direction) or vertical position (in the z-direction) of the optical path of excitation light 402 may be adjustable to ensure excitation light 402 is directed through a surface layer of medium 404 as the position of the surface layer is changed. Adjusting the volume of medium 404 in reservoir 406 along with the position of the optical path of excitation light 402 may allow excitation light channels 402 to sweep across an area of sample 410. In some embodiments, such sweeping may cause different fluorophores in sample 410 to fluoresce, allowing different areas of sample 410 to be imaged.

In some embodiments, medium 404 (e.g., a soap film) may act as a waveguide to guide the excitation light before and/or after branching. In some embodiments, a light source for the excitation light may be moved in accordance with a movement of medium 404. For example, a laser light source may be disposed on a float such that the laser is floated level with the surface of the fluid in the reservoir and can continuously direct excitation light into a soap film that is floated atop the fluid, even as the level of the fluid may be varied over time.

In some embodiments, system 400 may comprise an objective lens 414 configured to magnify an image of sample 410. Optionally, objective lens 414 may be disposed along a fluorescence emission optical path between sample slide 412 and camera 416.

In some embodiments, system 400 may include a filter wheel 420 configured to filter one or more wavelengths of light as said light travels from sample 410 to camera 416. Optionally, filter wheel 420 may be disposed along a fluorescence emission optical path between sample slide 412 and camera 416. Optionally, filter wheel 420 may be disposed along the optical path of excitation light 320 between objective lens 414 and camera 416.

### EXAMPLES

The following are non-limiting examples.

### Prophetic Example 1—Branched Flow In Situ

In situ detection and analysis methods include detecting, quantifying, and/or mapping analytes (e.g., gene activity) to specific regions in a biological sample (e.g., a tissue sample or cells deposited on a surface) at cellular or sub-cellular resolution. A biological sample is obtained from a subject using a technique such as biopsy, surgery, or simply cells and/or other biological material from the subject. The biological sample is then processed or prepared for an assay, including for the purpose of detecting analyte endogenous to a biological sample, such as nucleic acid analytes and non-nucleic acid analytes (e.g., RNA, ssDNA, and cell surface or intracellular proteins and/or metabolites). This includes contacting in a sample using one or more labelling agents for analyte binding. A product of an endogenous analyte and/or a labelling agent can be an amplification product of one or more polynucleotides, for instance, a circular probe or circularizable probe or probe set. One can then use rolling circle amplification (RCA) to amplify signal. A target sequence for the probe can be in an endogenous, a labelling agent, or a product generated in the biological sample using an endogenous analyte and/or a labelling agent, target sequences includes or is associated with one or more barcode(s). In a barcode-based detection method, barcode sequences are detected for identification of other molecules including nucleic acid molecules (DNA or RNA). In situ assays can employ specific strategies for further optically encoding the spatial location of target analytes in a sample using sequential rounds of fluorescent hybridization. One can multiplex the biological assay by contacting a sample with a plurality of nucleic acid probes, allowing the probes to directly or indirectly bind target analytes, which may then be optically detected (e.g., by detectably-labeled probes using fluorophores). Optical detection including excitation of fluorescently labeled probes would utilize branched flow for fluorophore excitation using sparse excitation pattern, with resulting fluorescent emission serving to identify analyte molecules of interest, including spatial localization. Unlike conventional techniques, sparse excitation via branched flow minimizes optical crowding, through disordered spatial point excitation of individual molecule optical address, in a manner hereto unachieved by conventional means such as beam light excitation.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A method of imaging a sample using branched flow light, the method comprising:
directing excitation light from a light source through a potential toward a sample comprising a plurality of fluorophores, wherein a correlation length of the potential is greater than or equal to 350 nm and less than or equal to 800 nm, and wherein the correlation length of the potential is greater than a wavelength of the excitation light, such that the excitation light branches into a plurality of light channels that are incident upon and excite the plurality of fluorophores;
capturing an image of fluorescence emission emitted by the fluorophores.

2. The method of claim 1, wherein the light from the light source has a wavelength of greater than or equal to 330 nanometers and less than or equal to 780 nanometers.

3. The method of claim 1, wherein the light from the light source is coherent.

4. The method of claim 1, wherein the potential comprises a soap membrane.

5. The method of claim 1, wherein the correlation length of the potential characterizes variation of at least one dimension of the medium in at least one spatial direction.

6. The method of claim 5, wherein the variation of at least one dimension of the medium in at least one spatial direction is in the spatial direction of the propagation of the excitation light.

7. The method of claim 1, wherein the excitation light from the light source is pulsed.

8. The method of claim 1, wherein the plurality of light channels are capable of random optical address of individual molecules.

9. The method of claim 8, wherein a degree of randomness of the distribution of the light channels is determined by a difference between the correlation length of the potential and the wavelength of the excitation light.

10. A fluorescence imaging system comprising:
a light source configured to emit excitation light;
a sample slide configured to hold a sample to be imaged;
a medium providing a potential, wherein the medium is disposed in an optical path between the light source and the sample slide, wherein a correlation length of the potential is greater than or equal to 350 nm and less than or equal to 800 nm, wherein the correlation length of the potential is greater than a wavelength of the excitation light, and wherein the medium is positioned such that the excitation light branches into a plurality of light channels that are incident upon the sample slide, such that the light channels excite a plurality of fluorophores of the sample; and
a sensor configured to capture fluorescence emission light emitted by the plurality of fluorophores of the sample.

11-15. (canceled)

16. The imaging system of claim 10, wherein the medium comprises a soap membrane.

17. The imaging system of claim 16, further comprising a reservoir containing a liquid, wherein the soap membrane floats on the liquid.

18. The imaging system of claim 17, further comprising a pump configured to adjust a volume of the liquid in the reservoir.

19. The imaging system of claim 18, wherein a position of the light source is adjustable such that the excitation light is directed into the medium as the volume of the liquid in the reservoir is adjusted.

20. The imaging system of claim 19, wherein one or more optical components in the optical path between the light source and the sample slide are adjustable such that the excitation light is directed into the medium as the volume of the liquid in the reservoir is adjusted.

21. The imaging system of claim 17, comprising an agitation device configured to agitate the liquid in the reservoir.

22. The imaging system of claim 17, wherein the sample slide forms a portion of a wall of the reservoir.

23. The imaging system of claim 17, wherein a length of the reservoir is adjustable.

24. The imaging system of claim 10, comprising an optical filter wheel disposed in a fluorescence emission optical path between the sample slide and the sensor.

25. The method of claim 10, wherein the plurality of light channels are capable of random optical address of individual molecules, wherein a degree of randomness of the distribution of the light channels is determined by a difference between the correlation length of the potential and the wavelength of the excitation light.

26. (canceled)
